(19) United States
(12) Patent Application Publication
(10) Pub. No.: US 2012/0047292 A1
(43) Pub. Date: Feb. 23, 2012

(54) Monitoring System, Device Server, Host Computer, Monitoring Method, and Storage Medium

(75) Inventor: Nobuhiro Tamura, Nagoya-shi (JP)

(73) Assignee: BUFFALO INC., Nagoya-shi (JP)

(21) Appl. No.: 13/212,180

(22) Filed: Aug. 18, 2011

(30) Foreign Application Priority Data
Aug. 18, 2010 (JP) 2010-182828

(51) Int. Cl. G06F 3/00

(52) U.S. Cl. 710/17

(57) ABSTRACT

The present invention provides a monitoring system comprising a device server and a host computer, the monitoring system monitoring the operation state of at least one peripheral device. The device server includes: at least one peripheral device port; a power supply section for supplying power to the peripheral device; and a first control section for making control of starting and stopping supply of power. The host computer includes: a second control section for instructing the first control section to start or stop supplying power to a peripheral device, and accessing the peripheral device; and a display unit. The first control section reports online-status notification to the second control section when supply of power is started, and reports offline-status notification to the second control section when supply of power is stopped. The second control section detects that power is being supplied to a peripheral device, by receiving the online-status notification; detects that power is not being supplied to the peripheral device, by receiving the offline-status notification; and displays, on the display unit, information about the peripheral device, in a display mode that discriminates the case where power is being supplied to a peripheral device and the case where power is not being supplied to a peripheral device from each other.

### CROSS REFERENCE TO RELATED APPLICATION

The disclosure of Japanese Patent Application No. 2010-182828, filed on Aug. 18, 2010, is incorporated herein by reference.

### BACKGROUND OF THE INVENTION

1. Field of the Invention

The present invention relates to management of peripheral devices connected to a device server.

2. Description of the Background Art

Device servers for relaying communications between peripheral devices and a host computer have been known to date (for example, Japanese Laid-Open Patent Publication No. 2007-310796).

When a device server of this sort is requested by a host computer to acquire peripheral-device pertaining information that the peripheral device retains, if the peripheral device power source is on, the device server acquires the peripheral device information from the peripheral device and reports the information to the host computer. Yet if the peripheral device power source is off, in instances in which the device server still retains peripheral device information it acquired previously when the peripheral device was on, the device server will report the information to the host computer. Consequently, to date there have been situations where the host computer, although able to obtain information on a peripheral device, is yet unable to determine whether the peripheral device is on or off, and thus cannot monitor the operational state of the peripheral device in detail.

### SUMMARY OF THE INVENTION

An object of the present invention is to solve at least a part of the above problems, and to provide a device server and a monitoring system that allow a host computer to monitor the operation state of a peripheral device in more detail.

The present invention has been made to solve at least a part of the above problems. The first aspect of the present invention is a monitoring system including a device server and a host computer, the monitoring system for monitoring the operational state of at least one peripheral device connected to the device server. The device server comprises: at least one peripheral device port into which a peripheral device connects; a detection section for detecting whether or not a peripheral device is connected into the peripheral device port; a power supply section for supplying power to a peripheral device via the peripheral device port; and a first control section for controlling start and stop of supply of power from the power supply section to a peripheral device connected to the peripheral device port, and for, from the peripheral device, acquiring and retaining peripheral device information relating to the peripheral device. The host computer comprises: a second control section for instructing the first control section to start or stop supplying power to a peripheral device, for requesting the first control section to notify the second control section of peripheral device information relating to the peripheral device and for acquiring the peripheral device information, and for accessing a peripheral device; and a display unit for displaying the operational state of a peripheral device. The first control section is therein configured to report an online-status notification to the second control section when supply of power is started, and to report an offline-status notification to the second control section when supply of power is stopped. The second control section is configured to detect from receiving an online-status notification that power is being supplied to a peripheral device, detect from receiving an offline-status notification that power is not being supplied to a peripheral device, and display, on the display unit, information based on the acquired peripheral device information, in a display mode that discriminates power being supplied to a peripheral device from power not being supplied thereto.

Preferably, the first control section may be further configured so as, in response to the detection section having detected that connection between a peripheral device port and a peripheral device has been broken, to discard information in retains on that peripheral device; and the second control section may be further configured so as to detect, in response to having failed to acquire information on a peripheral device that connection between a peripheral device port and that peripheral device has been broken, and in response to connection between a peripheral device port and a peripheral device having been broken, to stop display on the display unit of information about that peripheral device.

Preferably, the first control section may be further configured so as, in response to the second control section having not accessed a peripheral device for a first predetermined period, to stop supply of power from the power supply section to that peripheral device, and report an offline-status notification to the second control section.

Preferably, the device server may include a plurality of the peripheral device ports; and the first control section controls start and stop of supply of power with respect to each peripheral device port individually.

The second aspect of the present invention is a device server which is connected to a host computer and to at least one peripheral device, the device server comprising: at least one peripheral device port into which a peripheral device connects; a detection section for detecting whether or not a peripheral device is connected to the peripheral device port; a power supply section for supplying power to a peripheral device via the peripheral device port; and a control section for: controlling start and stop of supply of power to a peripheral device; acquiring peripheral device information relating to the peripheral device, from the peripheral device, and retaining the peripheral device information; and notifying the host computer of the peripheral device information in accordance with a request from the host computer. The control section, if the detection section has detected that a peripheral device is connected to the peripheral device port and if the power supply section has started supplying power to the peripheral device, acquires and retains the peripheral device information, and reports online-status notification indicating that power is being supplied to the peripheral device, to the host computer; if the detection section has detected that a peripheral device is connected to the peripheral device port and if the power supply section has stopped supplying power to the peripheral device, reports offline-status notification indicating that power is not being supplied to the peripheral device, to the host computer; and if the detection section has detected that connection between the peripheral device port and a peripheral device has been terminated, discards the retained peripheral device information.

The second aspect of the present invention is a host computer which is connected to a device server and monitors the operation state of a peripheral device connected to the device server, the host computer comprising: a control section for acquiring, from the device server, online-status notification, offline-status notification, and peripheral device information relating to a peripheral device connected to the device server; and a display unit for displaying the operational state of a peripheral device. The control section instructs the device server to start or stop supplying power to a peripheral device; detects that supply of power to a peripheral device has been started, based on the online-status notification; detects that supply of power to a peripheral device has been stopped, based on the offline-status notification; and displays, on the display unit, information based on the peripheral device information, in a display mode that discriminates the case where power is being supplied to a peripheral device and the case where power is not being supplied to a peripheral device from each other.

The present invention can be implemented in a variety of modes. Besides a monitoring system, a device server, and a host computer, the present invention is also directed to, for example, a method for realizing their functions, and a computer-readable non-transitory storage medium having stored therein a program for realizing their functions.

The present invention can provide a device server and a monitoring system that allow a host computer to monitor the operation state of a peripheral device in more detail.

The present invention is suitable to, for example, a device server for relaying communication between a peripheral device and a host computer. In addition, the present invention is suitable to, for example, a peripheral device monitoring system including these devices. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the configuration of a peripheral device monitoring system according to an embodiment of the present invention;

FIG. 2 is a flowchart showing the operation of the peripheral device monitoring system according to the embodiment of the present invention;

FIG. 3 is a state shifting diagram of the operation state of the peripheral device monitoring system according to the embodiment of the present invention;

FIG. 4 is a diagram for explaining the operation of the peripheral device monitoring system according to the embodiment of the present invention performed when a peripheral device is connected;

FIG. 5 is a diagram for explaining the operation of stopping supply of power to a peripheral device performed by the peripheral device monitoring system according to the embodiment of the present invention; and

FIG. 6 is a diagram for explaining the operation of the peripheral device monitoring system according to the embodiment of the present invention performed when a peripheral device is accessed again.

### DESCRIPTION OF THE PREFERRED EMBODIMENTS

### Embodiments

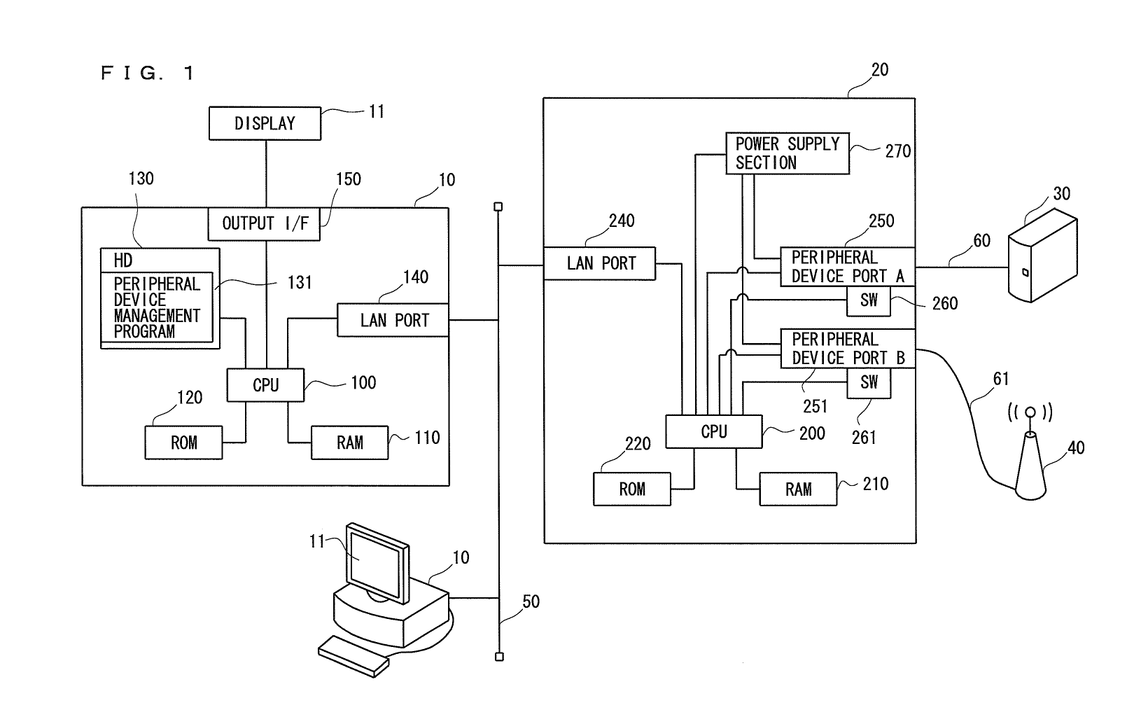

FIG. 1 is a diagram showing the configuration of a peripheral device monitoring system according to an embodiment of the present invention. The peripheral device monitoring system includes a host computer (HC) 10 and a device server 20. As an example, in the present embodiment, a hard disk 30 and a TV tuner 40 which are USB devices are connected, as peripheral devices, to the peripheral device monitoring system. In addition, in the present embodiment, the case where the hard disk 30 is monitored will be described as an example. However, a peripheral device to be monitored is not limited thereto. Other than this, a variety of peripheral devices such as a printer and a scanner may be monitored.

The host computer 10 and the device server 20 are connected via a LAN cable 50. The device server 20 and the hard disk 30 are connected via a peripheral device cable 60. The device server 20 and the TV tuner 40 are connected via a peripheral device cable 61. In the present embodiment, the peripheral device cables 60 and 61 are USB cables, as an example. The host computer 10 includes a display (display section) 11, and displays the operation state of the hard disk 30 on the display 11.

The host computer 10 includes a CPU 100 (second control section), a RAM 110, a ROM 120, a hard disk (HD) 130, a LAN port 140, and an output interface 150. The hard disk 130 stores a peripheral device management program 131. The CPU 100 executes the peripheral device management program 131 to control components of the device server 20, thereby monitoring and managing the operation state of each peripheral device connected to the device server 20. The display 11 is connected to the output interface 150.

The device server 20 includes a CPU 200 (first control section), a RAM 210, a ROM 220, a LAN port 240, a peripheral device port A250, a peripheral device port B251, switches 260 and 261, and a power supply section 270. The LAN cable 50 is connected to the LAN port 240, and the host computer 10 and the device server 20 are connected via the LAN cable 50. The hard disk 30 is connected to the peripheral device port A250 via the peripheral device cable 60, and the TV tuner 40 is connected to the peripheral device port B251 via the peripheral device cable 61. It is noted that since the peripheral device port A250 and the peripheral device port B251 have the same function, the TV tuner 40 may be connected to the peripheral device port A250, and the hard disk 30 may be connected to the peripheral device port B251. The switch 260 is a detection section for detecting whether or not the peripheral device cable 60 is connected to the peripheral device port A250, and the switch 261 is a detection section for detecting whether or not the peripheral device cable 61 is connected to the peripheral device port B251.

The power supply section 270 controls the supply of bus power to the peripheral device port A250 and the peripheral device port B251, in accordance with an instruction from the CPU 200. The CPU 200 controls the components of the device server 20, and if there is a power-off request from the host computer 10 or if a peripheral device has not been accessed (control of a peripheral device or input/output of data to a peripheral device has not been performed) for a first predetermined period, the CPU 200 stops supplying bus power to the peripheral device port A250 and the peripheral device port B251. It is noted that the CPU 200 controls each of the supply of bus power to the peripheral device port A250 and the supply of bus power to the peripheral device port B251 separately. For example, the CPU 200 can supply bus power to the peripheral device port A250 while stopping supplying bus power to the peripheral device port B251.

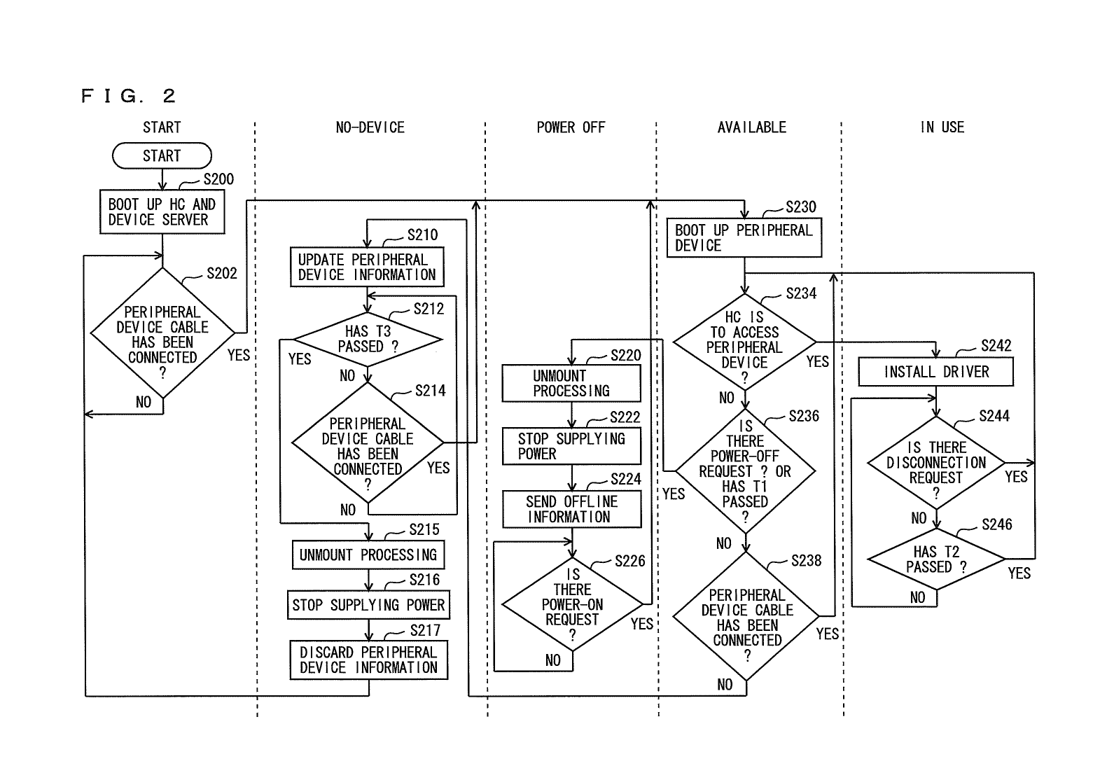

FIG. 2 is a flowchart showing the operation of the peripheral device monitoring system. Processing shown in this flowchart is executed for each of peripheral devices connected to the peripheral device ports separately, after step S200. There are five operation states of the peripheral device monitoring system, that is, a start state, a no-device state, a power-off state, an available state, and an in-use state, which correspond to the respective operation states of each peripheral device. Hereinafter, processing in each state will be described.

First, in step S200 in the start state, the host computer 10 and the device server 20 are booted up (step S200). Specifically, power switches (not shown) of the host computer 10 and the device server 20 are turned on by a user, whereby the host computer 10 and the device server 20 are booted up. At this point of time, the host computer 10 and the device server 20 have become communicable to each other via the LAN cable 50. If the CPU 100 of the host computer 10 has detected that the device server 20 has been booted up, the CPU 100 loads the peripheral device management program 131 from the hard disk 130 and executes the peripheral device management program 131, to start monitoring and managing the peripheral device. It is noted that the CPU 100 can execute the peripheral device management program 131 in accordance with an instruction from the user, irrespective of whether or not the device server 20 has been booted up.

In step S202, the CPU 200 of the device server 20 determines whether or not the peripheral device cable 60 has been connected to the peripheral device port A250. If the peripheral device cable 60 has been connected (YES in step S202), the CPU 200 of the device server 20 shifts processing to step S230. The CPU 200 can easily determine whether or not the peripheral device cable 60 has been connected to the peripheral device port A250, based on the state of the switch 260. The CPU 200 notifies the host computer 10 of information indicating whether or not the peripheral device cable 60 has been connected. In step S230, the corresponding peripheral device has become able to be accessed. If the peripheral device cable 60 is not connected (NO in step S202), the CPU 200 repeatedly executes the process of step S202, waiting for connection. When the peripheral device cable 60 is not connected to the peripheral device port A250, there is no peripheral device to be monitored.

When the operation state of the peripheral device monitoring system has shifted to the available state, the peripheral device monitoring system operates as follows. In step S230, the CPU 200 of the device server 20 boots up the hard disk 30 which is a peripheral device. As described later, step S230 includes: a power supply start process for starting supply of power to the hard disk 30 by supplying bus power to the peripheral device port A250; a mounting process for making a file in the hard disk 30 readable and writable (accessible) by the host computer 10; and an online-status notification reporting process for reporting, to the host computer 10, online-status notification indicating that the hard disk 30 has become accessible from the host computer 10 and has gone online to the device server 20. In addition, in step S230, the CPU 200 obtains peripheral device information from the hard disk 30. The peripheral device information is retained by the device server 20. In addition, in accordance with a request from the host computer 10, the peripheral device information retained by the device server 20 is sent from the device server 20 to the host computer 10. The host computer 10 obtains the peripheral device information as needed, and uses the obtained peripheral device information for monitoring/management, or access. If the hard disk 30 has gone online to the device server 20, the CPU 200 of the device server 20 becomes able to obtain the peripheral device information from the hard disk 30.

In step S234, if the CPU 100 of the host computer 10 is to access the hard disk 30 (YES in step S234), the CPU 100 shifts processing to step S242 and shifts the operation state of the peripheral device monitoring system to the in-use state. On the other hand, if the CPU 100 is not to access the hard disk 30 (NO in step S234), the CPU 100 shifts processing to step S236. Here, whether or not the CPU 100 of the host computer 10 is to access the hard disk 30 is determined by, for example, whether or not it is necessary to read or write a file in the hard disk 30 immediately.

In step S236, if the host computer 10 has made a power-off request for the hard disk 30 which is an instruction to stop supplying power to the hard disk 30, or if the first predetermined period T1 has passed since the process of step S230 was executed or since the latest return if the operation state of the peripheral device monitoring system returned from the in-use state (YES in step S236), the CPU 200 shifts processing to step S220 and shifts the operation state of the peripheral device monitoring system to the power-off state. In this way, it becomes possible to stop supplying power to a peripheral device that has not been accessed for the first predetermined period T1, even without a power-off request from the host computer 10. On the other hand, if there is not a power-off request for the hard disk 30 and the first predetermined period T1 has not passed (NO in step S236), the CPU 200 shifts processing to step S238.

In step S238, the CPU 200 determines whether or not the peripheral device cable 60 is connected to the peripheral device port A250. The CPU 200 can easily determine this by monitoring the state of the switch 260. If the peripheral device cable 60 is detached from the peripheral device port A250 (NO in step S238), the CPU 200 shifts processing to step S212 and shifts the operation state of the peripheral device monitoring system to the no-device state. On the other hand, if the peripheral device cable 60 is not detached from the peripheral device port A250 (YES in step S238), the CPU 200 shifts processing to step S234 to repeat the processes of the foregoing steps (steps S234 to S238).

Next, the case where the operation state of the peripheral device monitoring system is the in-use state will be described. In step S242, the host computer 10 becomes able to access the hard disk 30. Specifically, the CPU 100 of the host computer 10 installs a piece of software (a driver) for accessing the hard disk 30. As a result, the host computer 10 has become able to access the hard disk 30, whereby the host computer 10 has become able to read and write a file in the hard disk 30. In step S244, the CPU 100 determines whether or not there is a disconnection request from the host computer 10. If there is a disconnection request from the host computer 10 (YES in step S244), the CPU 100 shifts processing to step S234, and the operation state of the peripheral device monitoring system returns to the available state. A disconnection request is generated when the access from the host computer 10 to the hard disk 30 has been finished. If there is not a disconnection request (NO in step S244), the CPU 200 determines whether or not a second predetermined period T2 has passed since the process of step S242 was executed, in step S246. If the second predetermined period T2 has passed (YES in step S246), the CPU 200 shifts processing to step S234, and shifts the operation state of the peripheral device monitoring system to the available state. It is noted that if the host computer 10 has accessed the hard disk 30 before the second predetermined period T2 passes, the count of the elapsed time for the second predetermined period T2 is reset and another count is started. In this way, it becomes possible to shift the operation state of the peripheral device monitoring system to the power-off state after shifting the operation state to the available state, even if the host computer 10 has not accessed the hard disk 30 or has not made a disconnection request for the hard disk 30 for the second predetermined period T2. In addition, if the hard disk 30 is successively accessed, the in-use state can be kept. If the second predetermined period T2 has not passed (NO in step S246), the CPU 200 shifts processing to step S244 to repeat the processes of steps S244 and S246.

Next, the case where the operation state of the peripheral device monitoring system is the power-off state will be described. In step S220, the CPU 200 unmounts the hard disk 30. As a result, the host computer 10 becomes unable to access the hard disk 30 though the hard disk 30 is connected to the device server 20 in a physical sense. Next, in step S222, the CPU 200 controls the power supply section 270 to stop supplying power to the hard disk 30. In step S224, the CPU 200 reports offline-status notification to the host computer 10. In this way, the CPU 200 notifies the host computer 10 that the hard disk 30 has gone offline. In addition, if, for the first predetermined period T1, the host computer 10 has not accessed the hard disk 30 or made a power-off request for the hard disk 30, and the peripheral device cable 60 has not been detached, the CPU 200 of the device server 20 stops supplying power to the hard disk 30 to make the hard disk 30 offline. Thereafter, the CPU 200 of the device server reports offline-status notification to the host computer 10. In this way, the CPU 200 can notify the host computer 10 that the CPU 200 has stopped supplying power to the hard disk 30.

In step S226, the CPU 200 waits for the host computer 10 to make a power-on request for the hard disk 30, that is, an instruction to start supplying power to the hard disk 30. If the host computer 10 has made a power-on request, that is, an instruction to start supplying power to the hard disk 30 (YES in step S226), the CPU 200 shifts processing to step S230 and shifts the operation state of the peripheral device monitoring system to the available state.

Next, the case where the operation state of the peripheral device monitoring system is the no-device state will be described. In step S210, the peripheral device information about the hard disk 30 retained by the device server 20 is changed from the state in which the hard disk 30 is connected to the device server 20, to the state in which the hard disk 30 is not connected to the device server 20 (the state in which there is no device). In step S212, whether or not a third predetermined period T3 has passed since the process of step S210 was executed. If the third predetermined period T3 has passed (YES in step S212), the CPU 200 determines that connection between the hard disk 30 and the device server 20 has been terminated, executes an unmounting process (step S215), and stops supplying power (step S216). In the case where mounting process has not been performed, the process of step S215 is skipped. In the case where supply of power has not been started, the processes of steps S215 and S216 are skipped. This is the same as in the processes of steps S220 and S222. In addition, the CPU 200 discards the peripheral device information (step S217), shifts processing to step S202, and shifts the operation state of the peripheral device monitoring system to the start state. At this time, the host computer 10 fails to obtain the peripheral device information when the host computer 10 attempts to obtain the peripheral device information because the peripheral device information has been discarded, thereby detecting that the peripheral device cable has been detached from the peripheral device port. On the other hand, if the third predetermined period T3 has not passed (NO in step S212), the CPU 200 determines again whether or not the peripheral device cable 60 has been connected to the peripheral device port A250, in step S214. If the peripheral device cable 60 has been connected to the peripheral device port A250 (YES in step S214), the CPU 200 shifts processing to step S230, and shifts the operation state of the peripheral device monitoring system to the available state. It is noted that, in this case, since supply of power and mounting processes have been performed, among steps S231 to S233 described later which are included in step S230, steps S231 and S232 are skipped, while, in step S233, the peripheral device information is obtained (again) and the online-status notification is sent. On the other hand, if the peripheral device cable 60 is not connected to the peripheral device port A250 (NO in step S214), the CPU 200 shifts processing to step S212. Thereafter, the CPU 200 waits for the third predetermined period T3 to pass, repeating the processes of steps S212 and S214. While the CPU 200 is waiting, the unmounting process is not performed and supply of power to the hard disk 30 is not stopped. As a result, even if the peripheral device cable 60 is detached from the peripheral device port A250, if the peripheral device cable 60 is connected again within a certain period, the host computer 10 immediately becomes able to access the peripheral device. As a result, it becomes unnecessary to perform the power supply start process and the mounting process every time, for example, the peripheral device cable 60 is temporarily detached from the peripheral device port A250 owing to contact failure. In addition, when the CPU 200 is waiting, the peripheral device information includes information indicating that the hard disk 30 is not connected to the device server 20. The host computer 10 can detect that the host computer 10 cannot currently access the hard disk 30, by obtaining the peripheral device information.

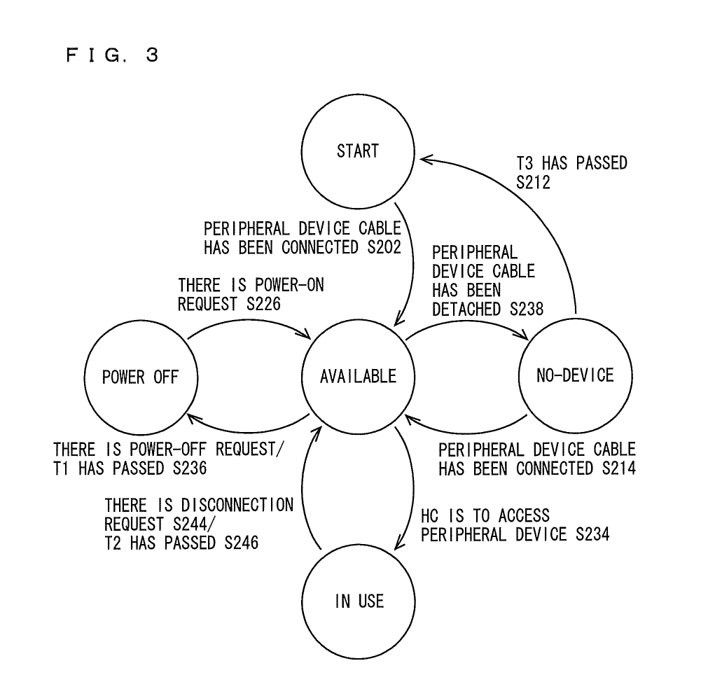

FIG. 3 is a state shifting diagram of the operation state of the peripheral device monitoring system. Operation states for the peripheral device monitoring system can be shifted to each other via the available state, as shown in FIG. 3.

For example, shifting from the start state to the available state is performed in the case where the result of step S202 in FIG. 2 is YES, that is, in the case where the peripheral device cable 60 connected to a peripheral device desired to be used has been connected to the peripheral device port A250 (FIG. 1) of the device server 20. It is noted that the available state cannot be directly shifted to the start state.

Shifting from the available state to the in-use state is performed in the case where the result of step S234 in FIG. 2 is YES, that is, in the case where the host computer 10 is to access a peripheral device. On the contrary, shifting from the in-use state to the available state is performed in the case where the result of step S244 in FIG. 2 is YES, that is, there is a disconnection request from the host computer 10 (FIG. 1); or in the case where the result of step S246 is YES, that is, the host computer 10 has not access the hard disk 30 or sent a disconnection request to the hard disk 30 for the second predetermined period T2.

Shifting from the available state to the power-off state is performed in the case where the host computer 10 (FIG. 1) has sent a power-off request (YES in step S236) before the second predetermined period T1 passes, or in the case where, for the first predetermined period T1, the host computer 10 has not accessed the hard disk 30 (NO in step S234) and the peripheral device cable 60 has not been detached (YES in step S238). On the other hand, shifting form the power-off state to the available state is performed in the case where the result of step S226 in FIG. 2 is YES, that is, there is a power-on request from the host computer 10.

Shifting from the available state to the no-device state is performed in the case where the result of the step S238 in FIG. 2 is NO, that is, the peripheral device cable 60 is detached from the peripheral device port A250 (FIG. 1). On the other hand, shifting from the no-device state to the available state is performed in the case where the result of step S214 in FIG. 2 is YES, that is, the peripheral device cable 60 has been connected to the peripheral device port A250.

Shifting from the no-device state to the start state is performed in the case where the result of step S212 in FIG. 2 is YES, that is, the third predetermined period T3 has passed while the peripheral device cable 60 is not connected. It is noted that the start state cannot be shifted to the no-device state.

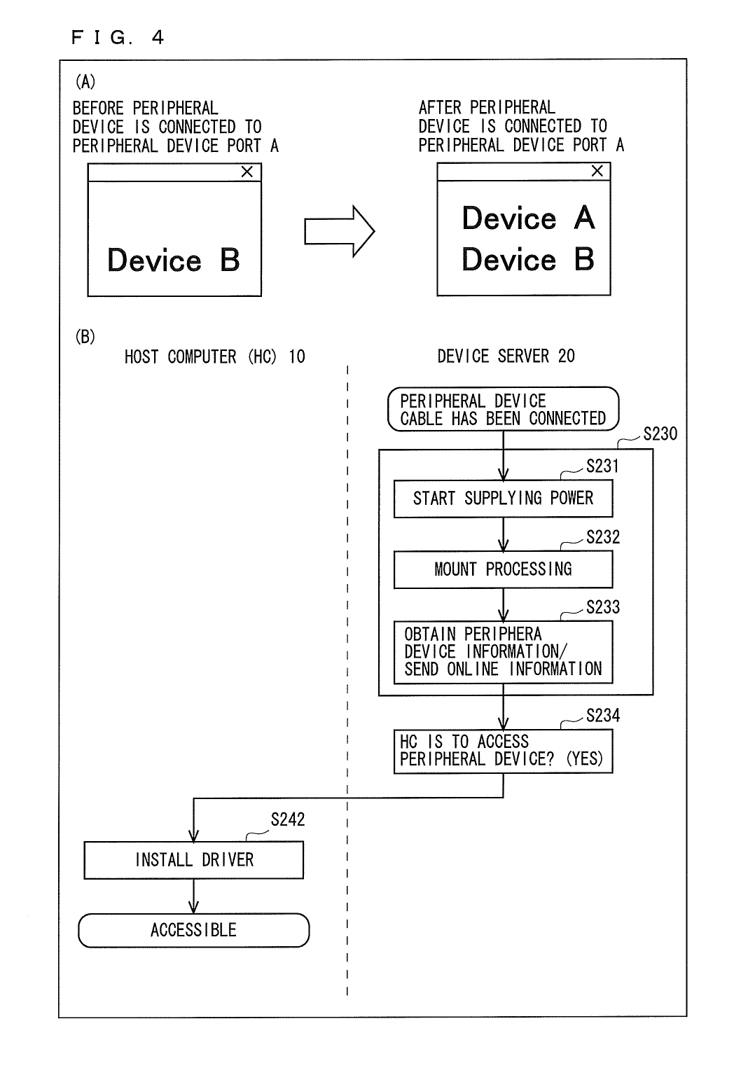

FIG. 4 is a diagram for explaining the operations of the device server 20 and the host computer 10 performed from when a peripheral device cable is connected until the corresponding peripheral device becomes accessible. (A) of FIG. 4 shows an example of a management screen displayed on the display 11 of the host computer 10, and (B) of FIG. 4 shows a flowchart of steps S230 to S243 which is included in the flowchart in FIG. 2. The process of step S230 will be described in detail, being divided into steps S231 to S233. Here, it will be assumed that the TV tuner 40 has been already connected to the peripheral device port B251, power being supplied to the TV tuner 40, and then the hard disk 30 is to be newly connected to the peripheral device port A250. In addition, in the flowchart, the process steps performed by the host computer 10 and the process steps performed by the device server 20 are indicated separately. Before the peripheral device cable 60 of the hard disk 30 is connected to the peripheral device port A250, only the TV tuner 40 is connected to the peripheral device port B251. Therefore, the CPU 100 of the host computer 10 has obtained only peripheral device information about the TV tuner 40, and as shown in (A) of FIG. 4, displays, on the management screen of the display 11, only “Device B” which indicates the TV tuner 40, for example.

In step S231, the CPU 200 of the device server 20 instructs the power supply section 270 to supply power to the hard disk 30. In step S232, the CPU 200 executes the mounting process for the hard disk 30. Then, in step S233, the CPU 200 reports online-status notification indicating that the hard disk 30 has gone online, to the host computer 10, and obtains peripheral device information from the hard disk 30. By these process steps, booting up of the hard disk 30 (peripheral device) is completed.

Here, the host computer 10 receives the online-status notification and immediately accesses the hard disk 30 (YES in step S234). In step S242, the CPU 100 of the host computer 10 installs a piece of software (a driver) for accessing the hard disk 30. As a result, the host computer 10 has become able to access the hard disk 30. As shown (A) of FIG. 4, when the CPU 100 of the host computer 10 has received the online-status notification, the CPU 100 displays, on the management screen of the display 11, “Device A” which indicates the hard disk 30 in addition to “Device B” which indicates the TV tuner 40, for example.

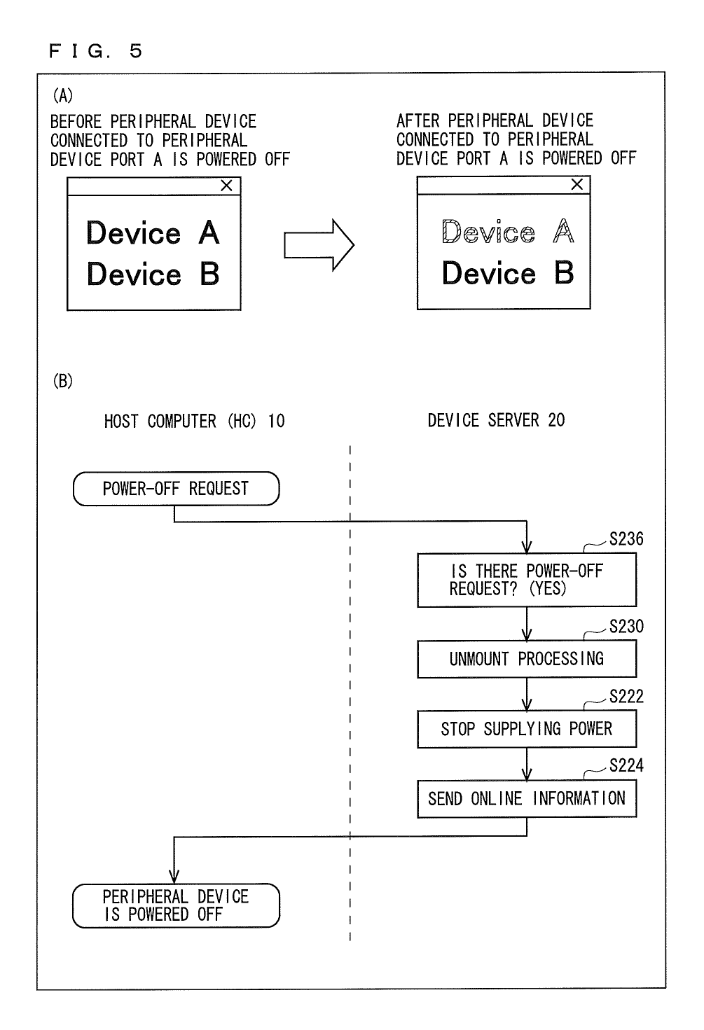

FIG. 5 is a diagram for explaining the operations of the device server 20 and the host computer 10 performed from when a power-off request for peripheral device is performed until supply of power is actually stopped. (A) of FIG. 5 shows an example of a management screen displayed on the display 11 of the host computer 10, and (B) of FIG. 5 shows a flowchart of steps S236 to S224 which is included in the flowchart in FIG. 2. Here, it will be assumed that the hard disk 30 has been already connected to the peripheral device port A250 and the TV tuner 40 has been already connected to the peripheral device port B251, power being supplied to both of them, and then the hard disk 30 is to be powered off. First, the host computer 10 transmits a power-off request to the device server 20, and the device server 20 receives the power-off request, whereby the result of the determination in step S236 becomes YES, and processing shifts to step S220. In step S220, the CPU 200 executes the unmounting process for the hard disk 30, and in step S222, the CPU 200 stops supplying power to the hard disk 30. In step S224, the CPU 200 reports, to the host computer 10, offline-status notification indicating that supply of power to the hard disk 30 has been stopped and the hard disk 30 has gone offline. It is noted that even if there is no power-off request from the host computer 10, if, for the first predetermined period T1, the host computer 10 has not accessed the hard disk 30 and the peripheral device cable 60 has not been detached, the CPU 200 executes the above processes.

If the host computer 10 has received the offline-status notification, the CPU 100 of the host computer 10 changes the content displayed on the display 11. For example, as shown in (A) of FIG. 5, “Device A”, which indicates the hard disk 30, displayed in black is to be displayed in gray. By display in gray, it is possible to notify the user that the hard disk 30 is connected to the device server 20 but the hard disk 30 is powered off. That is, in the present embodiment, by changing the indication of each peripheral device displayed on the management screen, it becomes possible to notify the user whether the peripheral device is ON or OFF. It is noted that if the peripheral device cable 60 is detached from the peripheral device port A250, the peripheral device information about the hard disk 30 is discarded, and the host computer 10 detects that the device server 20 no longer retains the peripheral device information. Based on the detection, for example, the indication of “Device A” itself, which indicates the hard disk 30, is stopped.

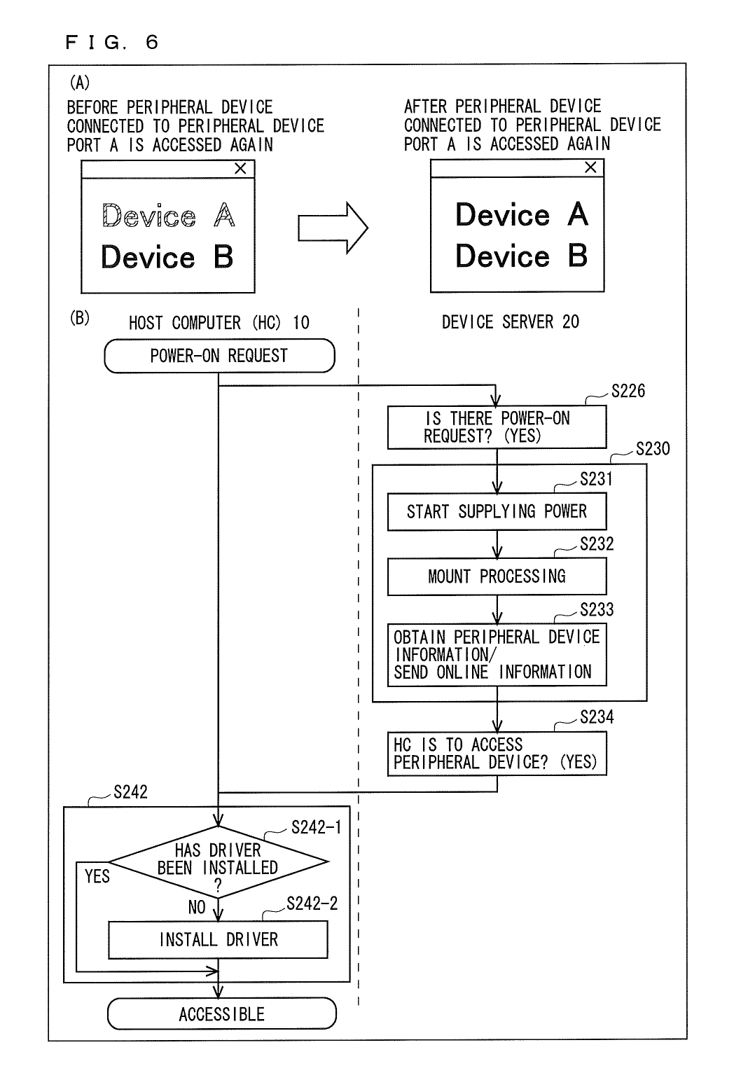

FIG. 6 is a diagram for explaining the operations of the device server 20 and the host computer 10 performed when a peripheral device is accessed again. Accessing again means that after a peripheral device has been once accessed and then supply of power to the peripheral device is stopped, power is to be supplied to the peripheral device again and the peripheral device is to be accessed again. (A) of FIG. 6 shows an example of a management screen displayed on the display 11 of the host computer 10, and (B) of FIG. 6 shows a flowchart of steps S226 to S243 which is included in the flowchart in FIG. 2. Here, it will be assumed that the TV tuner 40 has been already connected to the peripheral device port B251, power being supplied to the TV tuner 40; the hard disk 30 has been already connected to the peripheral device port A250, power not being supplied to the hard disk 30; the hard disk 30 is to be accessed again. The CPU 100 of the host computer 10 transmits a power-on request for the hard disk 30 to the device server 20, whereby the result of step S226 becomes YES. The processes of steps S231 to S233 are performed as previously described, and therefore the description thereof is omitted. Here, the process of step S242 will be described in detail, being divided into steps S242-1 and S242-2. In step S241-1, the CPU 100 of the host computer 10 confirms whether or not a piece of software (a driver) for accessing the hard disk 30 has been installed. Normally, in the case of accessing the hard disk 30 again, the piece of software (driver) for accessing the hard disk 30 has been already installed. In this case (YES in step S242-1), the hard disk 30 immediately becomes accessible. However, if the driver has been uninstalled for some reason (NO in step S242-1), the CPU 100 of the host computer 10 installs the driver (again) in step S242-2, and then the hard disk 30 becomes accessible. As a result, the host computer 10 can read and write a file in the hard disk 30. The CPU 100 of the host computer 100 receives online-status notification, and as shown in (A) of FIG. 6, changes the color of the indication of “Device A”, which indicates the hard disk 30, from gray to a normal color (original color, black), for example.

In this way, when a peripheral device is connected, the CPU 100 of the host computer 10 displays information about the peripheral device on the display 11 such that the case where power is being supplied to the peripheral device and the case where power is not being supplied to the peripheral device are discriminated from each other, whereby the host computer 10 can monitor the connection states of peripheral devices in more detail. In addition, for example, in the case where the specific name of each peripheral device is included in the corresponding peripheral device information, the host computer 10 may display the specific name such as “hard disk” or “TV tuner” based on the peripheral device information, instead of “Device A”.

In the present embodiment, monitoring and management for the hard disk 30 have been described as an example. However, in the present invention, a target of monitoring and management may be the TV tuner 40, or may be any peripheral device as long as the peripheral device is connected to the device server 20. Even in such cases, the operation state can be monitored in detail.

In addition, in the present embodiment, when a peripheral device cable is detached from a peripheral device port in the available state (NO in step S238), the operation state of the peripheral device monitoring system shifts to the no-device state. However, in any operation state, it is assumed that a peripheral device cable might be detached from a peripheral device port inadvertently. Also in such cases, the operation state may shift to the no-device state to execute the processes of steps S212 to S217, and then processing may shift to step S202. It is noted that, at this time, if the mounting process has not been performed, step S215 is skipped, and if supply of power has not been started, steps S215 and S216 are skipped. In addition, steps S210 to S214 may be skipped.

In the present embodiment, the case where peripheral devices are connected based on USB standard has been described as an example. However, the standard for connection between the device server and peripheral devices is not limited to USB standard. Another standard such as IEEE 1394 standard may be employed.

In the present embodiment, whether or not the peripheral device cable 60 is connected to the peripheral device port A250, and whether or not the peripheral device cable 61 is connected to the peripheral device port B251 are detected by the switches 260 and 261, respectively. However, a detection device other than a switch, for example, a sensor may be used. In addition, the device server may include any number of peripheral device ports, and any number of peripheral device may be monitored and managed by the peripheral device monitoring system.

In the present embodiment, when the peripheral device cable 60 is not connected to the peripheral device port A250, information about the hard disk 30 (peripheral device) is not displayed. On the other hand, when the peripheral device cable 60 is connected to the peripheral device port A250, if power is being supplied to the hard disk 30, information about the hard disk 30 is displayed in black, and if power is not being supplied to the hard disk 30, information about the hard disk 30 is displayed in gray, whereby the two cases are discriminated. However, the method for discrimination is not limited thereto, and various display manners may be employed. The indication of a peripheral device to which power is not being supplied may be displayed with a mark such as “x”, or the indication of a peripheral device to which power is being supplied may be displayed with a flag.

While the embodiments of the invention have been described in detail, the foregoing description of the embodiments of the invention is examples for facilitating the understanding of the invention, and does not limit the invention. It will be understood that numerous other modifications and variations can be devised without departing from the intention of the invention, and from the scope of claim of the invention, and that the equivalents for the invention are included.

What is claimed is:

1. A monitoring system including a device server and a host computer, the monitoring system for monitoring the operational state of at least one peripheral device connected to the device server, wherein:
the device server comprises
at least one peripheral device port into which a peripheral device connects,
a detection section for detecting whether or not a peripheral device is connected into the peripheral device port,
a power supply section for supplying power to a peripheral device via the peripheral device port, and
a first control section for controlling start and stop of supply of power from the power supply section to a peripheral device connected to the peripheral device port, and for, from the peripheral device, acquiring and retaining peripheral device information relating to the peripheral device,
the host computer comprises
a second control section for instructing the first control section to start or stop supplying power to a peripheral device, for requesting the first control section to notify the second control section of peripheral device information relating to the peripheral device and for acquiring the peripheral device information, and for accessing a peripheral device, and
a display unit for displaying the operational state of a peripheral device;
the first control section is therein configured to report an online-status notification to the second control section when supply of power is started, and to report an offline-status notification to the second control section when supply of power is stopped; and
the second control section is configured to
detect from receiving an online-status notification that power is being supplied to a peripheral device,
detect from receiving an offline-status notification that power is not being supplied to a peripheral device, and
display, on the display unit, information based on the acquired peripheral device information, in a display mode that discriminates power being supplied to a peripheral device from power not being supplied thereto.

2. The monitoring system according to claim 1, wherein:
the first control section is further configured so as, in response to the detection section having detected that connection between a peripheral device port and a peripheral device has been broken, to discard information in retains on that peripheral device; and
the second control section is further configured so as
to detect, in response to having failed to acquire information on a peripheral device that connection between a peripheral device port and that peripheral device has been broken, and
in response to connection between a peripheral device port and a peripheral device having been broken, to stop display on the display unit of information about that peripheral device.

3. The monitoring system according to claim 1, wherein the first control section is further configured so as, in response to the second control section having not accessed a peripheral device for a first predetermined period, to stop supply of power from the power supply section to that peripheral device, and report an offline-status notification to the second control section.

4. The monitoring system according to claim 1, wherein:
the device server includes a plurality of the peripheral device ports; and
the first control section controls start and stop of supply of power with respect to each peripheral device port individually.

5. A device server which is connected to a host computer and to at least one peripheral device, the device server comprising:
at least one peripheral device port into which a peripheral device connects;
a detection section for detecting whether or not a peripheral device is connected to the peripheral device port;
a power supply section for supplying power to a peripheral device via the peripheral device port; and
a control section for:
controlling start and stop of supply of power to a peripheral device;
acquiring peripheral device information relating to the peripheral device, from the peripheral device, and retaining the peripheral device information; and
notifying the host computer of the peripheral device information in accordance with a request from the host computer,
wherein the control section
if the detection section has detected that a peripheral device is connected to the peripheral device port and if the power supply section has started supplying power to the peripheral device, acquires and retains the peripheral device information, and reports online-status notification indicating that power is being supplied to the peripheral device, to the host computer,
if the detection section has detected that a peripheral device is connected to the peripheral device port and if the power supply section has stopped supplying power to the peripheral device, reports offline-status notification indicating that power is not being supplied to the peripheral device, to the host computer, and
if the detection section has detected that connection between the peripheral device port and a peripheral device has been terminated, discards the retained peripheral device information.

6. A host computer which is connected to a device server and monitors the operation state of a peripheral device connected to the device server, the host computer comprising:
a control section for acquiring, from the device server, online-status notification, offline-status notification, and peripheral device information relating to a peripheral device connected to the device server; and
a display unit for displaying the operational state of a peripheral device,
wherein the control section
instructs the device server to start or stop supplying power to a peripheral device,
detects that supply of power to a peripheral device has been started, based on the online-status notification,
detects that supply of power to a peripheral device has been stopped, based on the offline-status notification, and
displays, on the display unit, information based on the peripheral device information, in a display mode that discriminates the case where power is being supplied to a peripheral device and the case where power is not being supplied to a peripheral device from each other.

7. A method for, in a monitoring system including: a device server including a first control section; and a host computer including a second control section and a display unit, monitoring the operation state of at least one peripheral device connected to the device server, the method comprising:
a step of the second control section causing the first control section to start supplying power to a peripheral device;
a step of, when supply of power to a peripheral device has been started, the first control section acquiring peripheral device information relating to a peripheral device, from the peripheral device, retaining the peripheral device information, and reporting online-status notification to the host computer;
a step of the second control section detecting that power is being supplied to a peripheral device, by receiving the online-status notification;
a step of the second control section causing the first control section to stop supplying power to a peripheral device;
a step of, when supply of power to a peripheral device has been stopped, the first control section reporting offline-status notification to the host computer;
a step of the second control section detecting that power is not being supplied to a peripheral device, by receiving the offline-status notification;
a step of the second control section acquiring the peripheral device information from the first control section; and
a step of the second control section displaying, on the display unit, information based on the acquired peripheral device information, in a display mode that discriminates the case where power is being supplied to a peripheral device and the case where power is not being supplied to a peripheral device from each other.

8. A computer-readable non-transitory storage medium having stored a program therein, the program being executed by a control section of a host computer that includes a display unit, is connected to a device server, and monitors the operation state of a peripheral device connected to the device server, the program comprising:
a step of causing the device server to start supplying power to a peripheral device;
a step of detecting that power is being supplied to a peripheral device, by receiving online-status notification from the device server;
a step of causing the device to stop supplying power to a peripheral device;
a step of detecting that power is not being supplied to a peripheral device, by receiving offline-status notification from the device server;
a step of acquiring peripheral device information relating to a peripheral device connected to the device server, from the device server; and
a step of displaying, on the display unit, information based on the peripheral device information, in a display mode that discriminates the case where power is being supplied to a peripheral device and the case where power is not being supplied to a peripheral device from each other.
